(19) United States
(12) Patent Application Publication
(10) Pub. No.: US 2025/0042487 A1
(43) Pub. Date: Feb. 6, 2025

(54) TRACK SEGMENT FOR A SEGMENTED TRACK, VEHICLE HAVING SEGMENTED TRACKS, AND METHOD OF USING THE SAME

(71) Applicant: SOUCY INTERNATIONAL INC., Drummondville (CA)

(72) Inventors: Romeo LUSSIER, Sherbrooke (CA); Marc-Antoine LEBLANC, Drummondville (CA); Francois LAFLAMME, St-Germain-De-Grantham (CA); Magella BEDARD, Drummondville (CA); Olivier LECLERC, Drummondville (CA); Remi HAMELIN, Trois-Rivieres (CA); Jean-Philippe GAGNON, Drummondville (CA)

(21) Appl. No.: 18/717,563

(22) PCT Filed: Dec. 13, 2022
(86) PCT No.: PCT/CA2022/051812

§ 371 Date: Jun. 7, 2024

Related U.S. Application Data
(60) Provisional application No. 63/289,945, filed on Dec. 15, 2021.

(51) Int. Cl. B62D 55/253; B62D 55/26

(52) U.S. Cl. CPC B62D 55/253; B62D 55/26

(57) ABSTRACT

A track segment for a segmented track comprises a first track section and inner and outer couplers. A first connecting portion is disposed at one end of a body of the track section, defining a first inner section connector, a first outer section connector opposite from the first inner section connector, and a first engaging surface configured to abut on a second engaging surface of a second connecting portion of a second track section. The inner coupler has two inner coupler connectors configured to respectively connect to the first inner section connector of the first track section and to a second inner section connector of the second track section. An outer coupler has two outer coupler connectors configured to respectively connect to the first outer section connector of the first track section and to a second outer section connector of the second connecting portion of the second track section.

### CROSS-REFERENCE

The present application claims priority to U.S. Provisional Patent Application No. 63/289,945, filed Dec. 15, 2021 entitled “Track Segment For A Segmented Track, Vehicle Having Segmented Tracks, And Method Of Using The Same”, which is incorporated by reference herein in its entirety.

### TECHNICAL FIELD

The present technology relates to track systems. More precisely, the present technology relates to track segments for a segmented track, and a vehicle having segmented tracks.

### BACKGROUND

Certain vehicles, such as, for example, agricultural vehicles (e.g., harvesters, combines, tractors, etc.), construction vehicles (e.g., bulldozers, front-end loaders, etc.), all-terrain vehicles (ATV), utility task vehicles (UTV) and military vehicles are used on ground surfaces that are soft, slippery and/or uneven (e.g., soil, mud, sand, ice, snow, etc.).

Conventionally, such vehicles have had large wheels with tires on them to move the vehicle along the ground surface. Under certain conditions, such tires may have poor traction on some kinds of ground surfaces and, as these vehicles are generally heavy, the tires may compact the ground surface in an undesirable way owing to the weight of the vehicle.

In order to reduce the aforementioned drawbacks, to increase traction and to distribute the weight of the vehicle over a larger area on the ground surface, track systems were developed to be used in place of at least some of the wheels and tires on the vehicles. For example, under certain conditions, track systems enable construction vehicles to be used in wet field conditions as opposed to its wheeled counterpart. It has long been recognized that unitary endless elastomeric tracks had the fundamental problem of becoming mostly useless upon being damaged. Indeed, once such a track is damaged, it generally has to be completely replaced by a new elastomeric track.

To mitigate this problem while keeping the main advantages of elastomeric tracks (i.e., reduced noise, reduced weight, reduced damages on pavement, etc.), elastomeric tracks have sometimes been made of a plurality of interconnected elastomeric segments instead of being unitary.

Though elastomeric segmented tracks have their inherent advantages, such as providing the ability to replace only damaged or worn out segment or segments, segmented tracks also have their problems.

For instance, in order to connect each segment together, each segment is provided with joints. However, joints create discontinuities in the elastomeric material and in the longitudinal reinforcements (e.g., reinforcing cables or cords) where failures typically occur. Several segmented tracks have been proposed throughout the years to try to mitigate this and other problems, including for example in U.S. Pat. No. 9,315,225, to St-Pierre et al., issued on Apr. 19, 2016, the disclosure of which is incorporated by reference herein in its entirety.

However, heavy tracked vehicles, due to their inherent large size and weight, need to have tracks which, on the one hand, provide a large ground-contacting surface, and, on the other hand, are flexible enough to wrap around the various wheels of the vehicle (e.g., sprocket wheel, idler wheel and road wheels) and to absorb some temporary deformations.

Consequently, elastomeric tracks used on heavy track vehicles typically comprise several longitudinally extending track segments, each track segment including one or more substantially rigid sections (where inner and outer lugs are generally located) interconnected by generally shorter flexible and pliable sections (where bending generally occurs). Moreover, to maximize the ground-contacting surface of the track, the length of the flexible sections is usually significantly shorter than the length of the rigid sections.

In addition, the joint elements interconnecting the track segments need to be strong enough to support the longitudinal forces exerted by the vehicle during operation, and durable enough to prevent premature wearing. Despite recent advanced in the development of track systems, track segments may fail under harsh conditions and may need to be replaced. Conventional solutions for replacing track segments may involve the use of special tools in a workshop. However, as vehicles on which such track systems may be used on a farm, on a battlefield or in a construction zone, it would be desired to provide the capability to repair or replace track segments rapidly, on site, and without the need of special tools.

Therefore, there is a desire for a track system that can mitigate at least some of the above-mentioned issues.

### SUMMARY

According to one aspect of the present technology, there is provided a track segment for a segmented track. The track segment includes a first track section, an inner coupler and an outer coupler. The first track section includes a section body and a first connecting portion that is disposed at a first longitudinal end of the section body. The first connecting portion has a first inner connecting surface defining a first inner section connector, a first outer connecting surface that is opposite to the first inner connecting surface, and that defines a first outer section connector, and a first engaging surface extending between the first inner and outer connecting surfaces and configured to abut on a second engaging surface of a second connecting portion of a second track section. The inner coupler has a first inner coupler connector and a second inner coupler connector, the first and second inner couplers being longitudinally spaced from one another. The first inner coupler connector is configured to connect to the first inner section connector of the first connecting portion of the first track section, and the second inner coupler connector is configured to connect to a second inner section connector of the second connecting portion of the second track section. The outer coupler has a first outer coupler connector and a second outer coupler connector, the first and second outer coupler connectors being longitudinally spaced from one another. The first outer coupler connector is configured to connect to the first outer section connector of the first connecting portion of the first track section, and the second outer coupler connector is configured to connect to a second outer section connector of the second connecting portion of the second track section.

In some embodiments, the track segment further includes the second track section.

In some embodiments, the first track section comprises a second connecting portion at a second longitudinal end of the section body opposite from the first longitudinal end, the second connecting portion being configured to be connected to a third track section using a supplementary inner coupler and a supplementary outer coupler. In some embodiments, the track segment is reinforced with longitudinal reinforcing cables. The first track section includes a cable attachment section at a second longitudinal end of the section body opposite from the first longitudinal end, the cable attachment section being configured to receive first ends of the longitudinal reinforcing cables. The longitudinal reinforcing cables have second ends configured for attachment to another track segment.

In some embodiments, the section body is made of elastomeric material.

In some embodiments, the section body includes an inner surface having at least one inner body lug, and an outer surface opposite to the inner surface, the outer surface having at least one outer body lug. The inner coupler includes at least one inner coupler lug, and the outer coupler includes at least one outer coupler lug.

In some embodiments, the at least one inner body lug includes at least one driving lug and at least one guiding lug, and the at least one inner coupler lug comprises at least one driving lug and at least one guiding lug.

In some embodiments, the at least one outer body lug includes at least one ground-engaging lug, and the at least one outer coupler lug includes at least one ground-engaging lug.

In some embodiments, the at least one inner body lug and the at least one inner coupler lug are longitudinally spaced, and the at least one outer body lug and the at least one outer coupler lug are longitudinally spaced.

In some embodiments, the first and second connecting portions extend laterally along at least about 70% of a width of the first track section.

In some embodiments, each of the first and second inner section connectors forms one of an inner mortise and an inner tenon, and each of the first inner and second coupler connectors forms another one of the inner mortise and the inner tenon. Each respective pair including one the inner mortises and one of the inner tenons is configured to form an inner dovetail joint when the inner coupler is assembled with the first and second track sections.

In some embodiments, each of the first and second outer section connectors forms one of an outer mortise and an outer tenon, and each of the first outer and second coupler connectors forms another one of the outer mortise and the outer tenon. Each respective pair including one the outer mortises and one of the outer tenons is configured to form an outer dovetail joint when the outer coupler is assembled with the first and second track sections.

In some embodiments, the first engaging surface has a first anchoring portion, and the second engaging surface has a second anchoring portion.

In some embodiments, one of the first and second anchoring portions includes a plurality of laterally distributed tenons, another one of the first and second anchoring portions includes a plurality of laterally distributed mortises, and the plurality of laterally distributed mortises and the plurality of laterally distributed tenons are configured to form a plurality of laterally distributed dovetail joints when the first and second track sections are assembled.

In some embodiments, the first connecting portion has a first hook portion and the second connecting portion has a second hook portion.

In some embodiments, the first hook portion and the second hook portion are configured to align and temporarily hold the first connecting portion of the first track section relative to the second connecting portion of the second track section before the inner and outer couplers connect to the first and second track sections.

In some embodiments, at least one of the first track and second sections further includes a securing means for locking the inner and outer couplers to the first and second track segments.

In some embodiments, the inner and outer couplers are configured to form a rigid connection between the first and second track sections.

In some embodiments, the first connecting portion comprises a flexible portion between the first longitudinal end of the section body and the first inner and outer section connectors, whereby an assembly formed by connecting the inner coupler, the outer coupler and the first inner and outer section connectors may flex in relation to the section body.

According to another aspect of the present technology, there is provided a track segment for a segmented track. The track segment includes a first track section, at least one second track section, a first inner coupler and a first outer coupler. The first track section includes a first section body and a first connecting portion that is disposed at a first longitudinal end of the first section body. The first connecting portion includes a first inner connecting surface, a first outer connecting surface, a first engaging surface and a first cable attachment section. The first inner connecting surface defines a first inner section connector. The first outer connecting surface is opposite to the first inner connecting surface, and the first outer connecting surface defines a first outer section connector. The first engaging surface extends between the first inner and outer connecting surfaces. The first cable attachment section at a first longitudinal extremity of the first section body opposite from the first longitudinal end, the cable attachment section being configured to receive ends of at least one first longitudinal reinforcing cable. The at least one second track section includes a second section body, a second connecting portion disposed at a second longitudinal end of the second section body, and a third connecting portion disposed at a third longitudinal end of the third section body. The second connecting portion includes a second inner connecting surface, a second outer connecting surface and a second engaging surface. The second inner connecting surface defines a second inner section connector. The second outer connecting surface is opposite to the second inner connecting surface, and defines a second outer section connector. The second engaging surface extends between the second inner and outer connecting surfaces. The third connecting portion, which is disposed at a third longitudinal end of the third section body, includes a third inner connecting surface, a third outer connecting surface and a third engaging surface. The third inner connecting surface defines a third inner section connector. The third outer connecting surface is opposite to the third inner connecting surface, and defines a third outer section connector. The third engaging surface extending between the third inner and outer connecting surfaces. The first inner coupler includes a first inner coupler connector and a second inner coupler connector, the first and second inner couplers being longitudinally spaced from one another. The first inner coupler connector is configured to connect to the first inner section connectors of the first connecting portion of the first track section, the second inner coupler connector is configured to connect to the second inner section connector of the second connecting portion of the at least one second track section when the first engaging surface of the first track section abuts on the second engaging surface of the at least one second track section. The first outer coupler includes a first outer coupler connector and a second outer coupler connector, the first and second outer coupler connectors being longitudinally spaced from one another. The first outer coupler connector is configured to connect to the first outer section connector of the first connecting portion of the first track section, the second outer coupler connector is configured to connect to the second outer section connector of the second connecting portion of the at least one second track section when the first engaging surface of the first track section abuts on the second engaging surface of the at least one second track section.

In some embodiments, the at least one second track section comprises two or more second track sections, a first one of the second track sections being connected to the first track section by the first inner coupler and the first outer coupler, a second one of the two or more second track sections being connected to the first one of the two or more second track sections by a second inner coupler and a second outer coupler. In some embodiments, the track segment further includes a third track section, which includes a third section body, and a fourth connecting portion disposed at a fourth longitudinal end of the third section body. The fourth connecting portion has a fourth inner connecting surface, a fourth outer connecting surface, a fourth engaging surface and a second cable attachment section. The fourth inner connecting surface defining a fourth inner section connector. The fourth outer connecting surface is opposite to the fourth inner connecting surface, and defines a fourth outer section connector. The fourth engaging surface extends between the fourth inner and outer connecting surfaces. The second cable attachment section is at a second longitudinal extremity of the third section body opposite from the fourth longitudinal end, and is configured to receive first of at least one second longitudinal reinforcing cable. The third inner coupler has a third inner coupler connector and a fourth inner coupler connector, the third and fourth inner couplers being longitudinally spaced from one another. The third inner coupler connector is configured to connect to the third inner section connector of the third connecting portion of the at least one second track section, the fourth inner coupler connector is configured to connect to the second inner section connector of the second connecting portion of the at least one second track section when the third engaging surface of the at least one second track section abuts on the fourth engaging surface of the third track section. The third outer coupler have a third outer coupler connector and a fourth outer coupler connector, the third and fourth outer coupler connectors being longitudinally spaced from one another. The third outer coupler connector is configured to connect to the third outer section connector of the third connecting portion of the first at least one second track section, the fourth outer coupler connector is configured to connect to the second outer section connector of the second connecting portion of the at least one second track section when the third engaging surface of the at least one second section abuts on the fourth engaging surface of the third track section.

According to another aspect of the present technology, there is provided a segmented track including a plurality of track segments according to the above aspect or according to the above aspect and one or more of the above embodiments.

According to another aspect of the present technology, there is provided a vehicle including a frame, an engine supported by the frame, and at least two track systems operatively connected to the engine, each of the at least two track systems including the segmented track. According to another aspect of the present technology, there is provided a track coupling assembly for a segmented track. The track coupling assembly includes a first connecting portion of a first track section, a second connecting portion of a second track section, an inner coupler and an outer coupler. The first connecting portion has a first inner connecting surface, a first outer connecting surface and a first engaging surface extending between the first inner and outer connecting surfaces. The second connecting portion has a second inner connecting surface, a second outer connecting surface and a second engaging surface extending between the second inner and outer connecting surfaces. The second engaging surface of the first track section is configured to abut the first engaging surface of a second track section. The inner coupler is configured to connect to the first inner connecting surface of the first track section and to a second inner connecting surface of the second track section. The outer coupler is configured to connect to the first outer connecting surface of the first track section and to a second outer connecting surface of the second track section. Connection of the inner and outer couplers with the first and second connecting portions results in the first and second engaging surfaces abutting, and couples the first track section with the second track section.

According to another aspect of the present technology, there is provided a method for selectively and removably connecting a first track section of a segmented track to a second track section of the segmented track, the first and second track sections respectively having first and second inner section connectors and first and second outer section connectors. The method includes aligning the first track section with the second track section, connecting a first inner coupler connector of an inner coupler to the first inner section connector of the first track section, connecting a second inner coupler connector of the inner coupler to the second inner section connector the second track section, connecting a first outer coupler connector of an outer coupler to the first outer section connector of the first track section, connecting a second outer coupler connector of the outer coupler to the second outer section connector the second track section.

In some embodiments, connection of the first inner coupler connector to the first inner section connector of the first track section is done by a lateral translation, connection of the second inner coupler connector to the second inner section connector of the second track section is done by a lateral translation, connection of the first outer coupler connector to the first outer section connector of the first track section is done by a lateral translation, and connection of the second outer coupler connector to the second outer section connector of the second track section is done by a lateral translation.

In some embodiments, the first track section is aligned with the second track section by a first hook portion of the first track section and a second hook portion of the second track section.

In some embodiments, the inner and outer couplers are secured to the first and second track sections such that the inner and outer couplers are generally laterally fixed relative to the first and second track sections.

In some embodiments, the connection of the first and second track sections is performed manually.

In some embodiments, the first and second track sections are connected without specialized tools.

According to another aspect of the present technology, there is provided a track section for a segmented track. The track section includes a section body made of elastomeric material, and a coupler assembly. The section body includes an inner surface having at least one inner lug, an outer surface that is opposite the inner surface and that has at least one outer lug, a first body end and a second body end that opposite the first body end.

The first connecting portion is connected to the first body end of the section body and is configured to connect to a second connecting portion of a paired track section. The first connecting portion defines an inner joining surface including an inner section connector and including an inner section connector, an outer joining surface opposite the inner joining surface and including an outer section connector, and a first engaging surface extending from the inner joining surface to the outer joining surface. The coupler assembly includes an inner coupler and an outer coupler. The inner coupler has an inner lug portion and an inner connecting portion that is opposite to the inner lug portion, and that is complementary to the inner section connector of the first connecting portion of the track section, and to a second inner section connector of the paired track section. The outer coupler has an outer lug portion and an outer connecting portion that is opposite the outer lug portion, and that is complementary to the outer section connector of the first connecting portion of the track section, and to a second outer section connector of the paired track section. The inner coupler and the outer coupler are configured to respectively connect, via lateral translation, (i) to the inner section connector of the first connecting portion of the track section and to the second inner section connector of the paired track section, and (ii) to the outer section connector of the first connecting portion of the track section and to the second outer section connector of the paired track section, to thereby form a rigid joint between the first and second connecting portions when the first engaging surface of the track section abuts on a second engaging surface of the paired track section.

In some embodiments, the first and second connecting portions extend on at least 80% of a width of the section body.

In some embodiments, the at least one inner lug of the section body and the inner lug portion of the inner coupler are drive lugs or guide lugs.

In some embodiments, the at least one inner lug of the section body and the outer lug portion of the outer coupler are ground-contacting lugs.

In some embodiments, the inner connecting portion includes a first metallic part and the inner lug portion is connected to the first metallic part.

In some embodiments, the outer connecting portion includes a second metallic part and the outer lug portion is connected to the second metallic part.

In some embodiments, the first connecting portion is different from the second connecting portion.

In some embodiments, the first and second connecting portions each further comprises a complementary hook portion configured to temporarily align and hold the first and second connecting portions together during installation of the coupler assembly.

In some embodiments, the inner section connectors of the first and second connecting portions are configured to form one or more dovetail joints.

In some embodiments, the coupler assembly further comprises at least one mistake-proof feature.

In some embodiments, one of the at least one mistake-proof feature includes mortises formed on one of the inner and outer couplers and tenons formed on the other one of the inner and outer couplers, and corresponding tenons and mortises formed on the first and second connecting portions, whereby installing the inner coupler on the outer section connectors and to prevent installing the outer coupler on the inner section connectors is prevented.

In some embodiments, one of the at least one mistake-proof feature is formed by tapering, in a lateral direction, mortises on one of the first and second engaging surfaces and by tapering, in the lateral direction, tenons on the other one of the first and second engaging surfaces to prevent sliding the inner or outer couplers in an incorrect direction on the first and second connecting portions of the track sections.

In some embodiments, the coupler assembly further includes a securing means selectively preventing lateral translation of the inner and outer couplers relative to the track section.

In some embodiments, the securing means includes a separate part.

In some embodiments, the securing means is integrated in the track section and in the inner and outer couplers.

In some embodiments, a first of the engaging surfaces further includes a first anchoring portion and a second of the engaging surfaces further includes a second anchoring portion complementary to the first anchoring portion.

In some embodiments, the anchoring portions are configured to form a dovetail joint.

According to another aspect of the present technology, there is provided a segmented track for a tracked vehicle, the segmented track including a plurality of track sections according to the above aspect or according to the above aspect and one or more of its embodiments. The track sections are joined end-to-end to form a closed loop.

According to another aspect of the present technology, there is provided a vehicle having mounted thereto the segmented track of the above aspect.

According to another aspect of the present technology, there is provided a method for releasably joining track sections, each track section having an inner section connector and an outer section connector. The method includes aligning track sections with one another in an end-to-end configuration, engaging an inner coupler with the inner section connectors of each pair of adjacent track sections via a lateral translation, and engaging an outer coupler with the outer section connectors of each pair of adjacent track sections via a lateral translation.

In some embodiments, the track sections of each pair are temporary aligned by a hook portion.

In some embodiments, the method further includes securing the lateral movement of the inner and outer couplers using a securing means.

In some embodiments, the sections are connected without specialized tools.

According to another aspect of the present technology, there is provided a track segment for a segmented track. The track segment includes a first track section having a section body and a first connecting portion that is disposed at one end of the section body. The first connecting portion defines a first inner section connector, a first outer section connector opposite from the first inner section connector, and a first engaging surface configured to abut on a second engaging surface of a second connecting portion of a second track section. The track segment also includes inner and outer couplers. The inner coupler has a first inner coupler connector and a second inner coupler connector configured to respectively connect to the first inner section connector of the first track section and to a second inner section connector of the second track section. The outer coupler has a first outer coupler connector and a second outer coupler connector configured to respectively connect to the first outer section connector of the first track section and to a second outer section connector of the second connecting portion of the second track section.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a perspective view of a vehicle equipped with a pair of segmented tracks;

FIG. 2 is a fragmentary perspective view of the exterior of a track segment of the segmented tracks of FIG. 1;

FIG. 3 is a fragmentary perspective view of the interior of the track segment of the segmented tracks of FIG. 1;

FIG. 4 is a fragmentary plan view of the inner surface of two portions of the track segments of FIGS. 2 and 3, without plates and fasteners;

FIG. 5 is a schematic and functional view of a section of a track segment in accordance with an embodiment of the present technology;

FIG. 6 is a schematic and function view of the section of the track segment of FIG. 5 interconnecting with another section of the track segment by use of inner and outer couplers in accordance with an embodiment of the present technology;

FIG. 7 is a perspective view of an outer surface of a track segment comprising two sections in accordance with an embodiment of the present technology;

FIG. 8 is a side elevation view of the track segment of FIG. 7 in accordance with an embodiment of the present technology;

FIG. 9 is an exploded, perspective view of the track segment of FIG. 7 showing a first interconnection technique in accordance with an embodiment of the present technology;

FIG. 10 is an exploded, perspective view of the track segment of FIG. 7 showing a second interconnection technique in accordance with an embodiment of the present technology;

FIGS. 11 and 12 are a detailed views of the second interconnection technique in accordance with an embodiment of the present technology;

FIG. 13 is a plan view of an outer surface of a track segment comprising three sections in accordance with an embodiment of the present technology;

FIG. 14 is a perspective, detailed view of a snap-fit connection between an inner coupler and the connecting portion of a track section; and

FIG. 15 is a detailed view of hook portions usable for temporary alignment of two track sections.

It should be noted that, unless otherwise explicitly specified herein, the drawings are not to scale.

### DETAILED DESCRIPTION

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

It must be noted that, as used in this specification and the appended claims, the singular form “a”, “an” and “the” include plural referents unless the context clearly dictates otherwise.

As used herein, the term “about” in the context of a given value or range refers to a value or range that is within 20%, preferably within 10%, and more preferably within 5% of the given value or range.

As used herein, the term “and/or” is to be taken as specific disclosure of each of the two specified features or components with or without the other. For example, “A and/or B” is to be taken as specific disclosure of each of (i) A, (ii) B and (iii) A and B, just as if each is set out individually herein.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of implementations of the present technology will become apparent from the following description, the accompanying drawings, and the appended claims.

The present disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including”, “comprising”, or “having”, “containing”, “involving” and variations thereof herein, is meant to encompass the items listed thereafter as well as, optionally, additional items. In the following description, the same numerical references refer to similar elements.

In the context of the following description, “longitudinal” means in a direction parallel to a forward direction of travel of a vehicle, and “lateral” means in an orthogonal direction from the direction of travel of the vehicle. In the same context, “outwardly” or “outward” means away from a longitudinal center plane of a track system, and “inwardly” or “inward” means toward the longitudinal center plane. In addition, in the context of the following description, the longitudinal center plane of the track system in a plane parallel to flat level ground, “laterally” means in a direction perpendicular to the longitudinal center plane in a plane parallel to flat level ground, and “generally vertically” means in a direction contained in the longitudinal center plane along a height direction of the track system generally perpendicular to flat level ground. Also, the term “wheel assemblies” include all the necessary structure (bearing structures, pins, axles and other components) to permit a structure/wheel to pivot/rotate about an axis, as the case may be. In the following description and accompanying Figures, track systems are configured to be attached to right and left sides of the chassis of the vehicle. In the context of the present technology, the qualification of a wheel assembly as “at least indirectly connected” includes a wheel assembly that is directly connected to the at least one wheel-bearing frame member as well as a wheel assembly that is connected to the wheel-bearing frame member through an intermediate structure or structures, be they intermediate frame members or otherwise.

The present technology will be presented in the context of a particular application of segmented tracks mounted on a military vehicle. It should however be understood that this example does not limit the present technology. The disclosed segmented track technology could be applied to various other types of tracked vehicles, including, for example and without limitation, agricultural vehicles (e.g., harvesters, combines, tractors, etc.), construction vehicles (e.g., bulldozers, front-end loaders, etc.), all-terrain vehicles (ATV) and utility task vehicles (UTV).

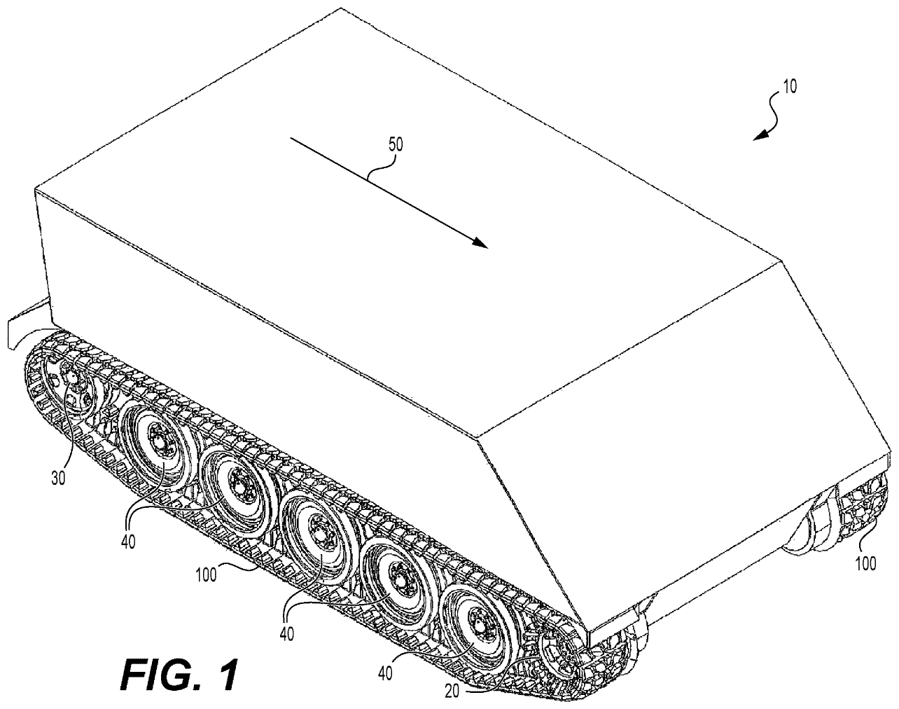

Referring to FIG. 1, segmented tracks 100 are shown mounted on a vehicle 10. In the present non-limiting example, the vehicle 10 is an armored personnel carrier and comprises, on each side thereof, wheel assemblies including a sprocket wheel 20 mounted at the front end of the vehicle 10, an idler wheel 30 mounted at the rear end of the vehicle 10, and several road wheels 40 mounted along the length of the vehicle 10.

The sprocket wheel 20 is generally configured to engage the segmented track 100 and to transmit motive power from the engine (not shown) of the vehicle 10 to the segmented track 100. The idler wheel 30 is configured to tension and to guide the segmented track 100 at the rear end of the vehicle 10. Finally, in the illustrated example, the road wheels 40 are generally configured to guide the lower run portion of the segmented track 100 which engages the ground during use.

On FIG. 1, an arrow 50 indicates a forward direction of travel of the vehicle 10.

The segmented track 100 comprises at least one but typically several track segments 200, which are connected end-to-end such as to define an endless loop as best illustrated in FIG. 1.

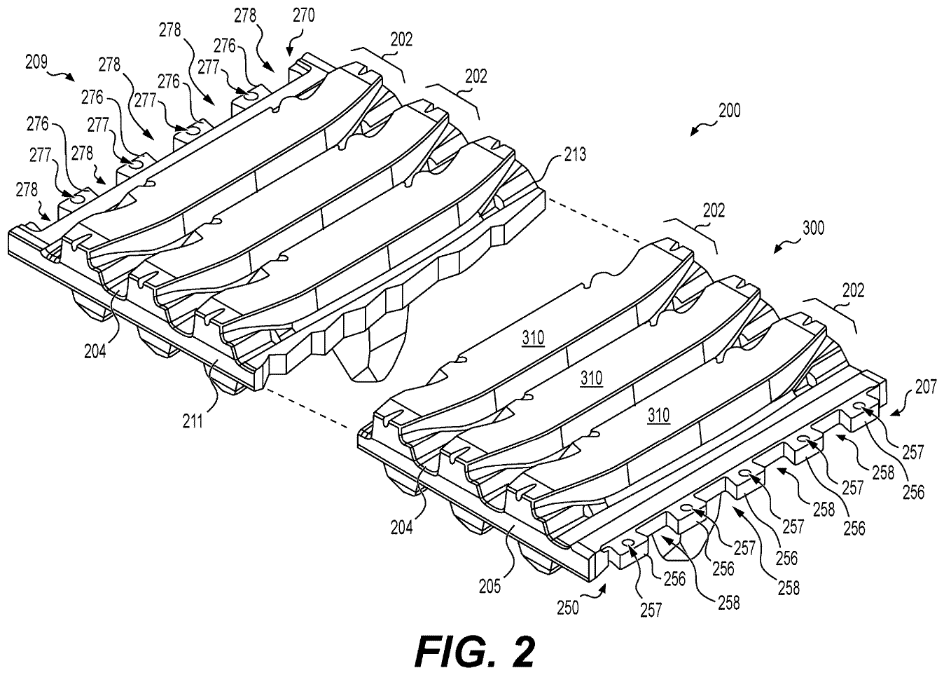

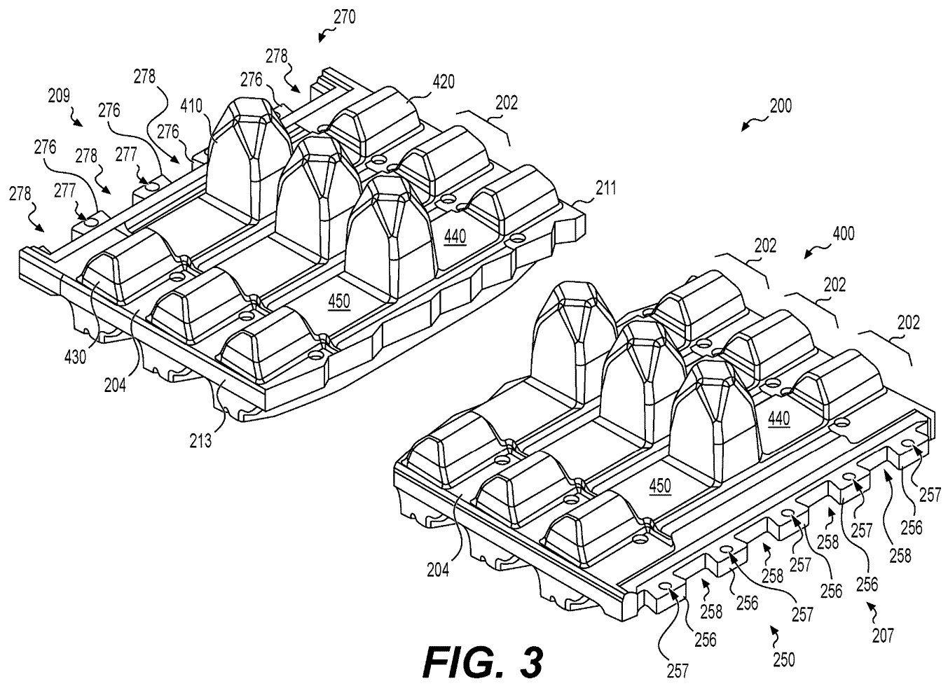

Referring now to FIGS. 2 and 3, a conventional track segment 200 is shown in more details. Each track segment 200 is made from reinforced elastomeric material and generally comprises a basic body or carcass 205 having an outer ground-engaging surface 300 and an inner wheel-engaging surface 400.

The body 205 defines a first extremity 207, and second opposite extremity 209, a first side edge 211 and a second opposite side edge 213. Understandably, the track segments 200 can be of varying length as indicated by the broken lines in FIGS. 2 and 3. Each track segment 200 includes one or more longitudinally aligned rigid track sections 202 with a flexible track section 204 disposed between and connecting each pair of adjacent track sections 202.

The outer surface 300 comprises one or more tread or traction lugs 310 (collectively referred to as outer lugs), for example and without limitation one traction lug 310 on each rigid track section 202. The traction lugs 310 are configured to engage the ground over which the vehicle 10 is operated. The traction lug(s) 310 of the track segment 200 generally define a tread pattern.

The inner surface 400 comprises one or more rows of longitudinally aligned drive lugs and/or guide lugs (collectively referred to as inner lugs). In the present non-limiting example, each track section 202 includes, on the inner surface 400, one substantially centrally located guide lug 410 and two drives lugs 420 and 430 respectively located substantially along the side edges 211 and 213 of the track segment 200. It is understood that, in certain embodiments, the centrally located guide lug 410 is a driving lug and the drive lugs 420 and 430 are guiding lugs. In some other embodiments, the drive lugs 420 and 430 can be omitted, and the centrally located guide lug 410 thus act as a driving lug and a guiding lug.

The guide lugs 410 are generally configured to guide the segmented track 100 over the various wheels 20, 30 and 40 of the vehicle 10 and to prevent occurrences of de-tracking. The guide lugs 410 are typically not positively driven nor engaged by the sprocket wheel 20. For their parts, the drive lugs 420 and 430 are configured to be drivingly engaged by the sprocket wheel 20 of the vehicle 10. It is understood that different configurations of engagement between the segmented track 100 and the sprocket wheel 20 are contemplated as well.

In the example of FIGS. 2 and 3, the rows of guide lugs 410 and drive lugs 420 and 430 are laterally spaced apart such as to define wheel paths 440 and 450 for the different wheels 20, 30 and 40 of the vehicle 10.

In other examples, there could be more or less than two rows of drive lugs 420, 430 and the row or rows of drive lugs 420, 430 could be located elsewhere along the width of the track segment 200. Similarly, in other examples, there could be more than one row of guide lugs 410 and the row or rows of guide lugs 410 could be located elsewhere along the width of the track segment 200.

Also, though in the present example, the guide lugs 410 are typically not positively driven nor engaged by the sprocket wheel 20, in other examples, the guide lugs 410 could possibly be driven by the sprocket wheel 20. In such examples, the guide lugs 410 would act both as guide lugs and as drive lugs.

The track segment 200 also comprises a first joint member 250 located at the first extremity 207 and a second joint member 270 located at the second extremity 209.

As illustrated, the first joint member 250 includes five outwardly extending tails 256 spaced apart by four recesses 258. Complementarily, the second joint member 270 defines five recesses 278 configured to receive the five tails 256 of an adjacent track segment 200, and four tails 276 configured to be received in the four recesses 258 of an adjacent track segment 200.

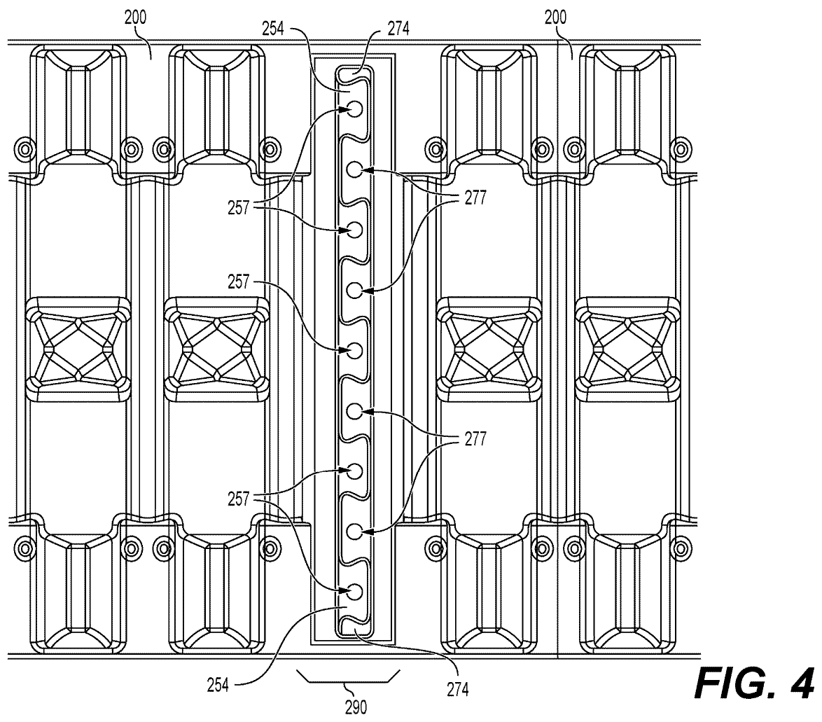

As best shown in FIG. 4, the joint members 250 and 270 are configured to form a common rigid joint 290 when they are engaged to each other and further fastened using plates and fasteners, for example bolts (not shown) inserted in openings 257 and 277 of the first and second joint members 250 and 270. In operation, as the vehicle 10 is moving, shear forces and bending forces are applied on these bolts, which may eventually cause them to fail.

Generally speaking, track segments have been modified from the configuration of FIGS. 2 to 4 to define track sections that can be selectively connected and disconnected from one another by use of a coupling arrangement, for example when there is a need to repair or replace a portion of the segmented track 100. A so-modified track segment comprises a first track section and usually comprises a plurality of longitudinally disposed track sections. Each track section comprises a section body and at least one connecting portion disposed at one end of the section body. Another connecting portion may be disposed at an opposite end of the section body, except when the track section is at an extremity of a track segment. The connecting portion has an inner section connector, an outer section connector opposite from the inner section connector, and an engaging surface configured to abut on an engaging surface of another connecting portion of another track section. Two adjacent track sections having their engaging surfaces in abutment may be connected using an inner coupler and an outer coupler of the coupling arrangement. The inner coupler has two inner coupler connectors configured to respectively connect to the inner section connectors of the two adjacent track sections. The outer coupler has two outer coupler connectors configured to respectively connect to the outer section connectors of the two adjacent track sections. In some embodiments, the entire segmented track 100 may be constructed using these track sections assembled into track segments that are joined end-to-end to form a closed loop. In the same or other embodiments, the vehicle 10 may be equipped with segmented tracks 100 constructed in whole or in part using these track sections.

In an embodiment, a repair kit for the segmented track 100 may comprise one inner coupler, one outer coupler, and one track section. Should a portion of the segmented track 100 break while in the field, one of more repair kits may be used to replace damaged parts of the segmented track 100, for example one section, two sections or all sections of a track segment.

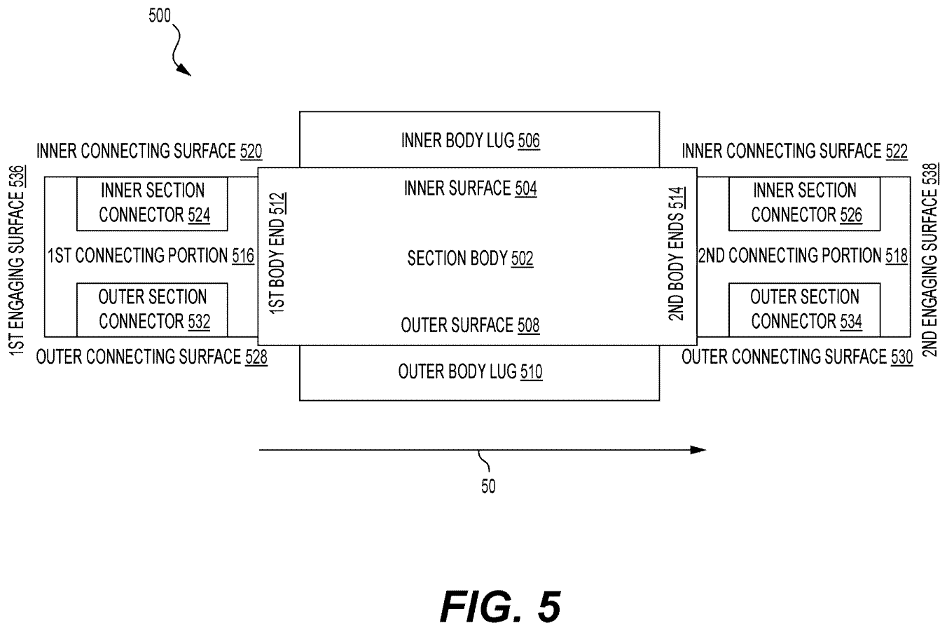

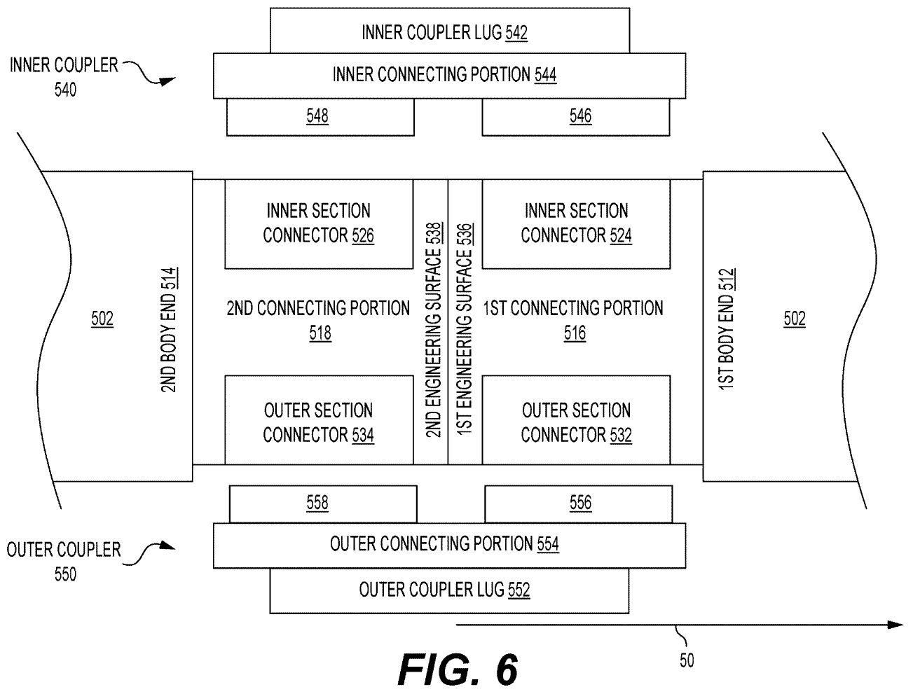

FIG. 5 is a schematic and functional view of a section of a track segment in accordance with an embodiment of the present technology. FIG. 6 is a schematic and function view of the section of the track segment of FIG. 5 interconnecting with another section of the track segment by use of inner and outer couplers in accordance with an embodiment of the present technology. Referring to FIGS. 5 and 6, on which the arrow 50 indicates a forward direction of travel of the vehicle 10 on which the segmented track 100 is mounted, a track segment for a segmented track 100 comprises a first track section 500, an inner coupler 540 and an outer coupler 550. The first track section 500 comprises a section body 502 and a first connecting portion 516 disposed at a first longitudinal end 512 of the section body 502. The first connecting portion 516 may extend laterally along at least about 70%, at least about 75%, at least about 80%, at least about 85%, or at least about 90%, of a width of the first track section 500. In some instances, the first connecting portion 516 may extend laterally along between about 70% and about 90% of a width of the first track section 500.

The first track section 500 may comprise a second connecting portion 518 disposed at an opposite, second longitudinal end 514 of the section body 502. The first connecting portion 516 has a first inner connecting surface 520 defining a first inner section connector 524, a first outer connecting surface 528 opposite to the first inner connecting surface 520, the first outer connecting surface defining a first outer section connector 532, and a first engaging surface 536 extending between the first inner and outer connecting surfaces 520, 528 and configured to abut on a second engaging surface 538 of a second connecting portion 518 of a second track section 500. The inner coupler 540 has a first inner coupler connector 546 and a second inner coupler connector 548 mounted to an inner connecting portion 544, the first and second inner couplers 546, 548 being longitudinally spaced from one another, the first inner coupler connector 546 being configured to connect to the first inner section connector 524 of the first connecting portion 516 of the first track section 500, the second inner coupler connector 548 being configured to connect to a second inner section connector 526 of the second connecting portion 518 of the second track section 500. The outer coupler 550 having a first outer coupler connector 556 and a second outer coupler connector 558 mounted to an outer connecting portion 544, the first and second outer coupler connectors 556, 558 being longitudinally spaced from one another, the first outer coupler connector 556 being configured to connect to the first outer section connector 532 of the first connecting portion 516 of the first track section 500, the second outer coupler connector 558 being configured to connect to a second outer section connector 534 of the second connecting portion 518 of the second track section 500. The inner and outer couplers 540, 550 form a rigid connection between the first and second track sections 500 when assembled.

In embodiments as shown in FIG. 5, where the first track section 502 comprises the second connecting portion 518, the second connecting portion 518 is configured to be connected to a third track section 500 using a supplementary inner coupler 540 and a supplementary outer coupler 550. Like the first connecting portion 516, the second connecting portion 518 may extend laterally along at least about 70%, at least about 75%, at least about 80%, at least about 85%, or at least about 90%, of a width of the first track section 500. In some instances, the first connecting portion may extend laterally along between about 70% and about 90% of a width of the first track section 500.

FIGS. 5 and 6 illustrate an embodiment in which the section body 502 includes an inner surface 504 having at least one inner body lug 506, and an outer surface opposite 508 to the inner surface 504, the outer surface 508 having at least one outer body lug 510. Similarly, the inner coupler 540 includes at least one inner coupler lug 542 mounted to the inner connecting portion 544, and that the outer coupler 550 includes at least one outer coupler lug 552 mounted to the outer connecting portion 554. The at least one inner body lug 506 may comprise at least one inner lug, and the at least one inner coupler lug 542 may comprise at least one inner lug. The at least one outer body lug 510 may comprise at least one ground-engaging lug and the at least one outer coupler lug 552 may comprise at least one ground-engaging lug. Being longitudinally spaced, the inner body lugs 506 and the inner coupler lugs 542 may act as guide lugs and drive lugs. Being also longitudinally spaced, the outer body lugs 510 and the outer coupler lugs 552 may form a thread pattern for the segmented track 100.

In a non-limiting embodiment, the section body 502 and the first connecting portion 516 may be made of an elastomeric material. In the same or another non-limiting embodiment, the inner connection portion 544 of the inner coupler 540 and/or the outer connecting portion 554 of the outer coupler 550 may include metallic parts and the inner and/or outer coupler lugs 542, 552 may be connected to these metallic parts.

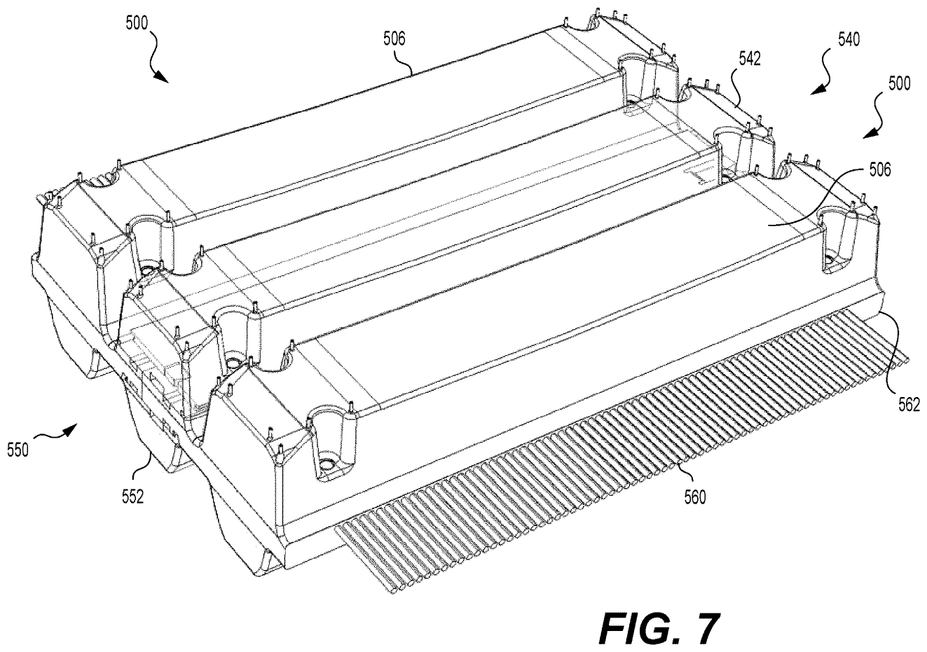

FIG. 7 is a perspective view of an outer surface of a track segment comprising two sections in accordance with an embodiment of the present technology. On FIG. 7, two track sections 500 are assembled using the inner coupler 540 (shown in transparency) and the outer coupler 550. The inner body lugs 506 and one of the outer coupler lug 552 are clearly visible; the inner coupler lug 542 is not clearly visible because of the transparent showing of the inner coupler 540.

In the embodiment of FIG. 7, the track segment is reinforced with longitudinal reinforcing cables 560. Some of the track sections 500, as shown on FIG. 7, comprises a cable attachment section at a second longitudinal end (or extremity) 562 of the section body 502 opposite from the first longitudinal end 512. For example, an array of cables 560 may be mounted to the second longitudinal end 562 of the track section 500. The cable attachment section is where first ends of the longitudinal reinforcing cables are received in the track section 500. The longitudinal reinforcing cables have second ends (not shown) for attachment to a track section 500 of another track segment.

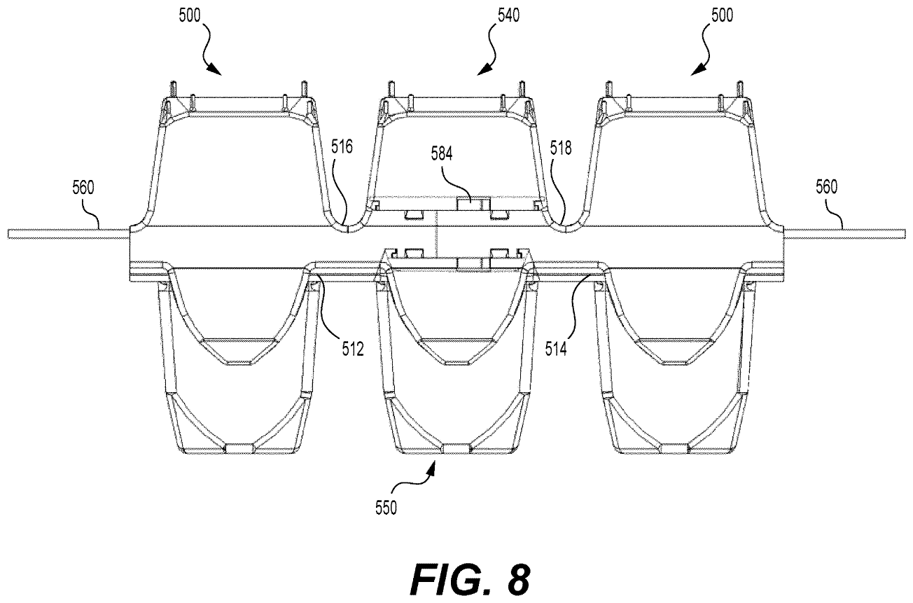

FIG. 8 is a side elevation view of the track segment of FIG. 7 in accordance with an embodiment of the present technology. The inner and outer couplers 540 and 550 are shown in transparency, to reveal the metallic parts of the inner and outer connecting portions 544, 554 on which the inner and/or outer coupler lugs 542, 552 may be connected. The connecting portions 516, 518 may each comprise a flexible portion between the longitudinal end 512, 514 of the section body 502 and the inner and outer section connectors 524, 526, 532, 534, to allow an assembly formed by connecting the inner coupler 540, the outer coupler 550 and the inner and outer section connectors 524, 526, 532, 534 to flex in relation to the section body 502 of each of the track sections 500.

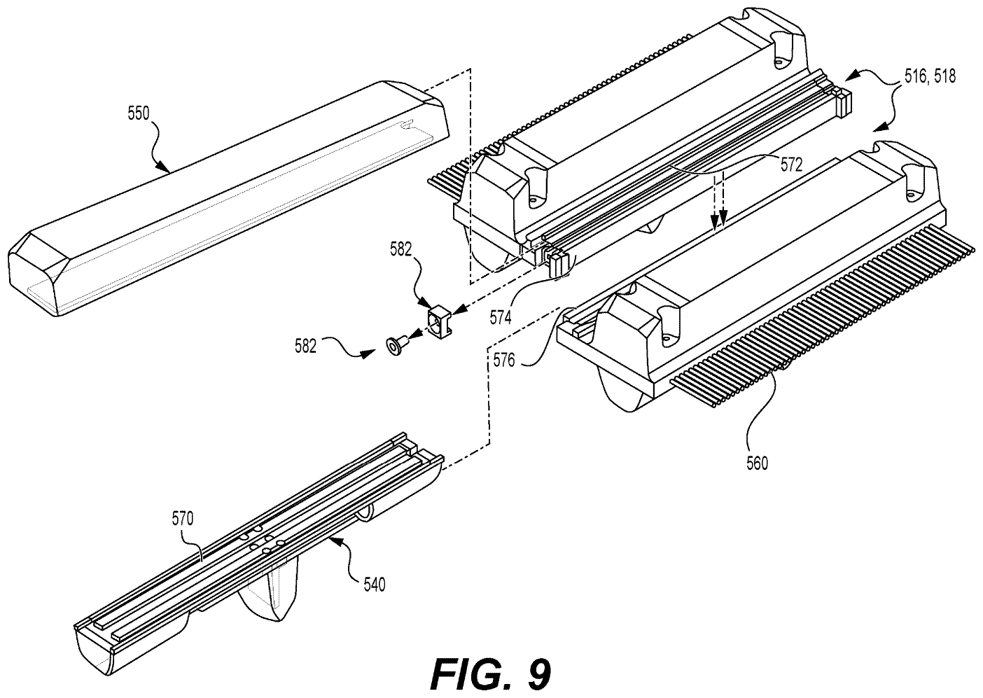

FIG. 9 is an exploded, perspective view of the track segment of FIG. 7 showing a first interconnection technique in accordance with an embodiment of the present technology. As shown on FIG. 9, in an embodiment, each of the first and second connecting portions 516, 518 forms a mortise 572 on the outer surfaces 528, 530 and the inner coupler 540 forms a pair of tenons 570. Although not shown, each of the first and connecting portions 516, 518 forms a mortise on the inner surfaces 520, 522 and the outer coupler forms a pair of tenons. Dovetail joints may be formed between each respective pair including one of the mortises and one of the tenons when the inner and outer couplers 540, 550 are assembled with the first and second track sections 500. In the non-limiting example of FIG. 9, the inner coupler 540 has a pair of tenons 570 configured to slidably fit in a corresponding pair of mortises (not shown) on the first and second inner section connectors 524, 526. Similarly, the outer coupler 550 has a pair of tenons (not shown) configured to slidably fit in a corresponding pair of mortises 572 of the first and second outer section connectors 532, 534. Forming tenons on the first and second inner section connectors 524, 526 and forming mortises on the inner and outer couplers 540, 550 is also contemplated. In an embodiment, the tenons and the corresponding mortises may be configured so that the inner coupler 540 and the outer coupler 550 snugly connect to the first and second track sections in an interference fit, preventing accidental relative movement between these parts once assembled. It is also contemplated that mortises could be formed on one of the inner and outer couplers 540, 550, tenons being formed on the other one of the inner and outer couplers 540, 550, with corresponding tenons and mortises being formed on the first and second connecting portions 516, 518, as this could form a mistake-proof feature preventing installing the inner coupler 540 on the outer side and installing the outer coupler on the inner side. Another mistake-proof feature may be formed by tapering the mortises and tenons in the lateral direction, preventing any attempt to slide the inner or outer couplers 540, 550 in an incorrect (i.e. reverse) direction on the first and second connecting portions 516, 518 of the track sections 500. Other configurations for forming mechanical interlocking connections between the inner coupler 540 and the two tract sections 500 are also contemplated.

The embodiment of FIG. 9 also shows that the first engaging surface 536 has a first anchoring portion 574, and that the second engaging surface 538 has a corresponding second anchoring portion 576. The first and second anchoring portions 574, 576 may be engaged by sliding the first and second engaging surfaces 536, 538 on one another.

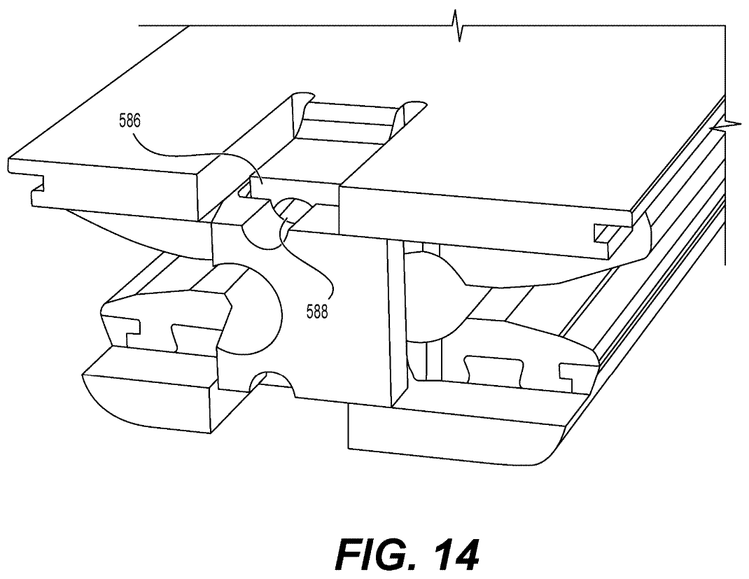

FIG. 9 also shows a securing means including a U-shaped plate 580 and a bolt 582 that can be attached to the assembly formed by the two track sections 500, the inner coupler 540 and the outer coupler 550, to lock the inner and outer couplers 540, 550 to indentations 584 (FIG. 8) on the first and second track segments 500 when assembled. In an embodiment as shown on FIG. 14, the U-shaped plate 580 and the bolt 582 may be omitted, as a biased lip 586 may be integrally formed on an end of the inner or outer coupler 540, 550, the biased lip 586 being configured for mating in a snap-fit connection with an indentation 588 integrally formed near an end of the first and second connecting portions 516, 518. The indentation 588 may possibly be the same as the indentation 584. It is alternatively possible to form a biased lip at the end of the first and second connecting portions 516, 518 and to form an indentation on an end of the inner or outer coupler 540, 550, to also allow forming a snap-fit connection for maintaining the inner or outer coupler 540, 550 in place on the first and second connecting portions 516, 518. In the same or another embodiment, one securing means constructed according to any one of these techniques may be mounted at each opposite end of the assembly. Other types of securing means are also contemplated.

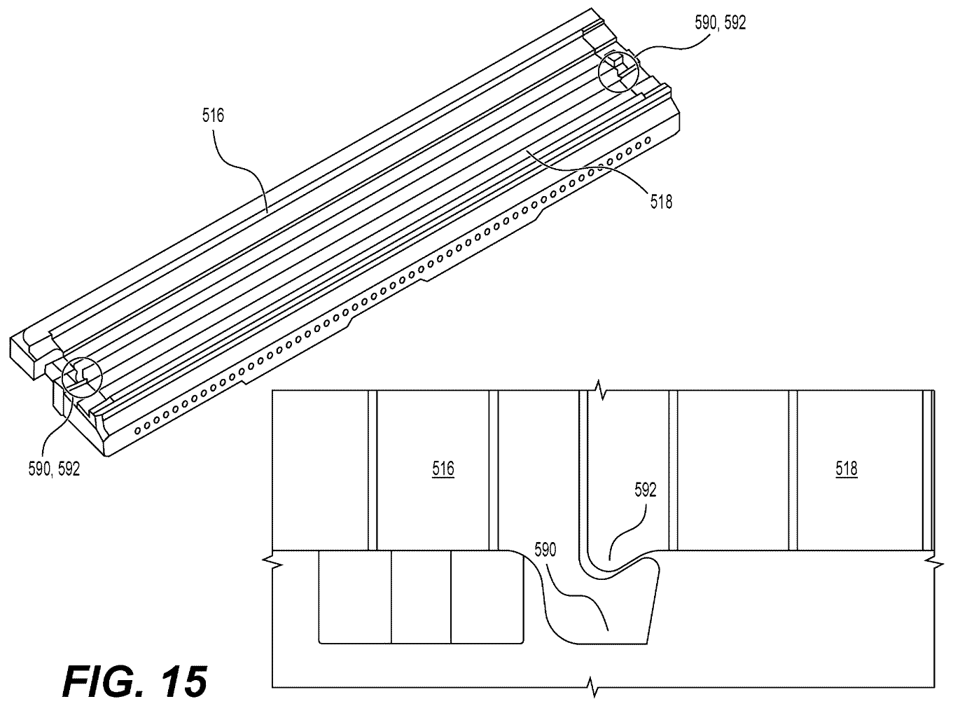

The segmented track 100 may be very heavy. In order to facilitate the assembly of the track sections 500 and of the inner and outer couplers 540, 550, the first connecting portion 516 may have a first hook portion 590 and the second connecting portion 518 may have a second hook portion 592. FIG. 15 provides details of the first and second hook portions 590, 592. Hook portions 590, 592 may be positioned on both ends of the first and second connecting portions 516, 518. The first and second hook portions 590, 592 are complementary and may be configured to align the first connecting portion 516 of the first track section 500 to the second connecting portion 518 of the second track section 500 before the inner and outer couplers 540, 550 connect to the first and second track sections 550. The engagement of the first hook portion 590 with the second hook portion 592 temporarily holds the first and second track sections 500 together in an aligned disposition while the inner and outer couplers 540, 550 are installed. This temporary support of the first and second track sections 500 in this aligned disposition facilitates the insertion of the inner and outer couplers 540, 550 in the first and second connecting portions 516, 518, rendering the process more time-efficient. Once the assembly is complete, the first and second hook portions 590, 592 are still engaged with one another but do not support the first and second track sections 500 anymore. It may be noted that first connecting portion 516 may have a hook portion similar to the hook portion 592 while the second connection portion 518 may have a hook portion similar to the hook portion 590. Different hook portions 590 or 592 may be formed at opposite ends of each of the first and second connecting portions 516, 518.

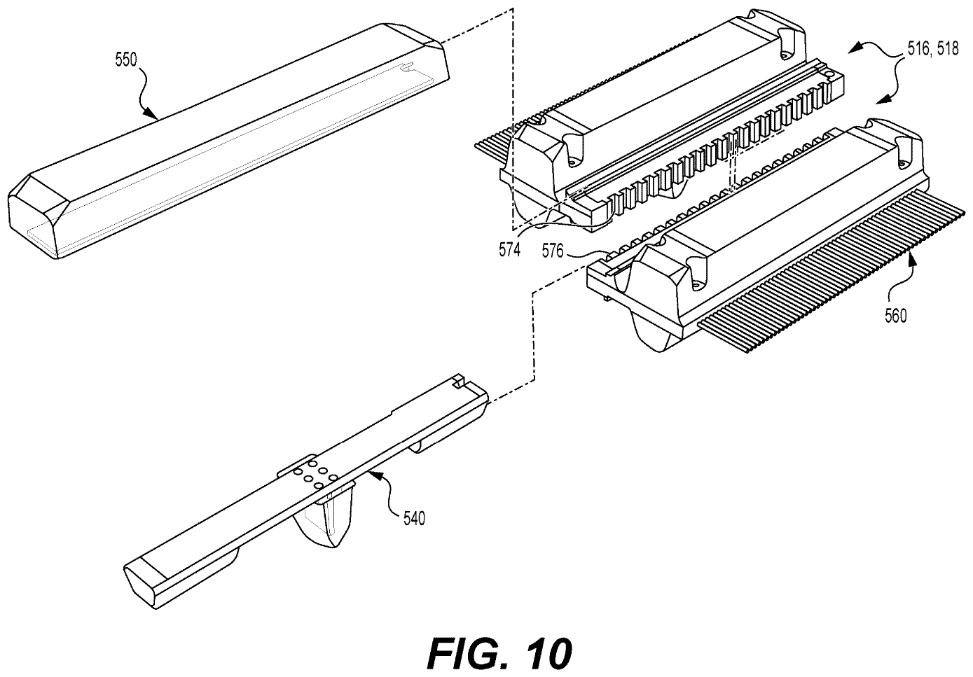

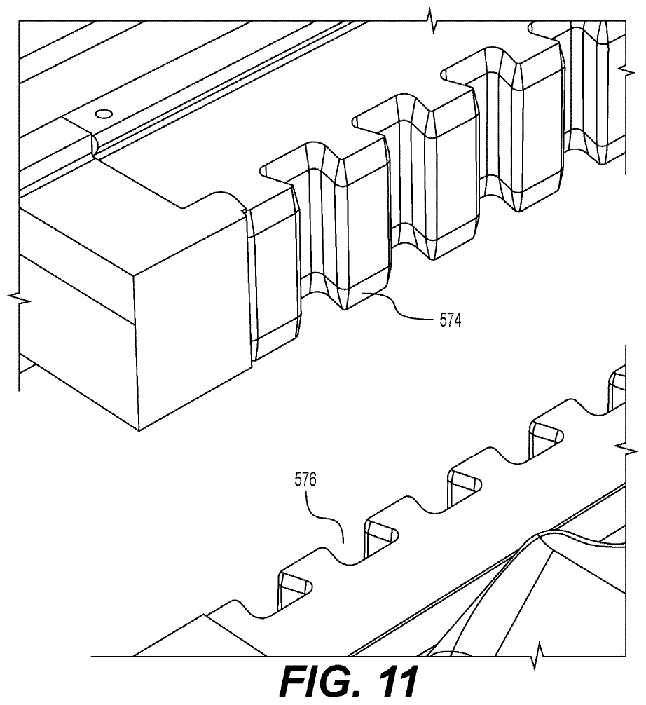

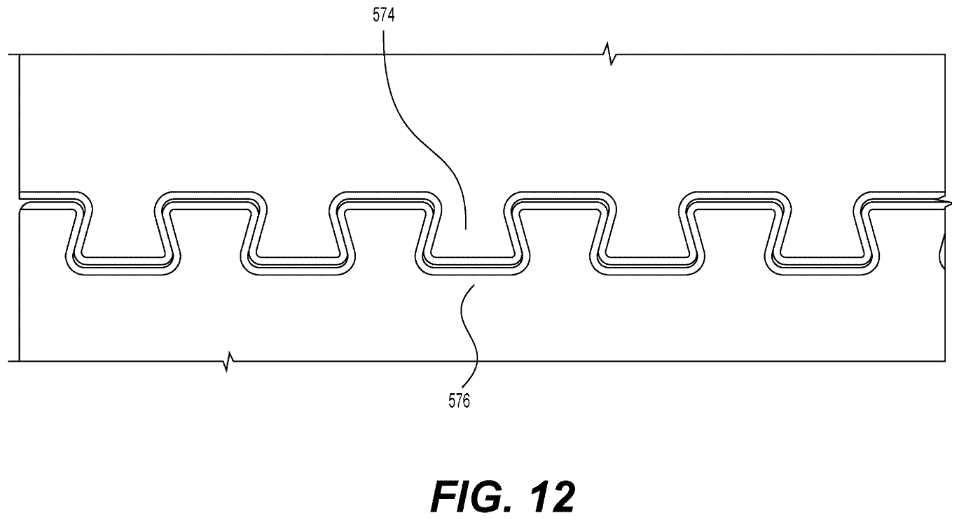

FIG. 10 is an exploded, perspective view of the track segment of FIG. 7 showing a second interconnection technique in accordance with an embodiment of the present technology. FIGS. 11 and 12 are a detailed views of the second interconnection technique in accordance with an embodiment of the present technology. In the embodiment of FIGS. 10, 11 and 12, one of the first and second anchoring portions 574 and 576 includes a plurality of laterally distributed tenons while another one of the first and second anchoring portions 574 and 576 includes a plurality of laterally distributed mortises. The plurality of laterally distributed mortises and the plurality of laterally distributed tenons form a plurality of laterally distributed mechanical interlocking joints (e.g., dovetail) when the first and second track sections 500 are assembled. In this non-limiting embodiment, the two anchoring portions 574, 576 mirror each other, but other configurations are contemplated. Embodiments having the first and second interconnection techniques provide a particularly rigid joint between the inner and outer couplers 540, 550 and the first and second track sections 500, with an excellent track durability in heavy duty/vehicles applications.

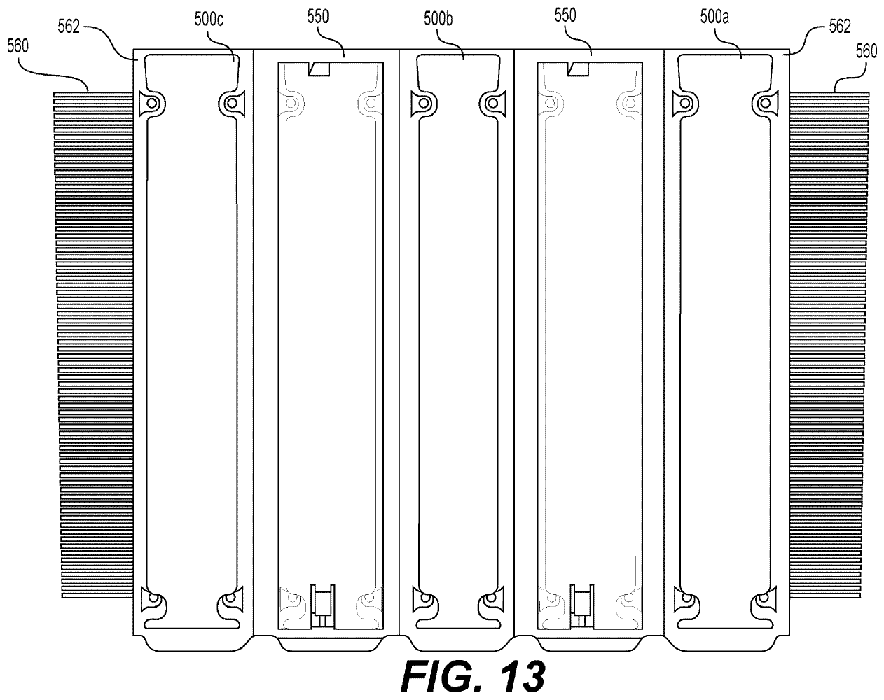

FIG. 13 is a plan view of an outer surface of a track segment comprising three sections in accordance with an embodiment of the present technology. A track segment comprises a first track section 500a, at least one second track section 500b (one second track section 500b is shown) and a third track section 500c. The track segment could comprise the first and third track sections 500a and 500c at both ends, and a plurality of interconnected second track sections 500b in between. All the track sections 500a, 500b, 500c are constructed in the same manner, except for the first and second track sections 500a, 500c that each have a connecting portion such as 516 or 518 one longitudinal end, and a cable attachment section 560 at an opposite longitudinal end (or extremity) 562. One inner coupler 540 and one outer inner coupler 550 are used to connect each pair of adjacent track sections 500a, 500b, 500c.

Without limiting the scope of the present technology, a first track section 500 of the segmented track 100 may be selectively and removably connected to a second track section 500 of the segmented track 100 in the following manner. The first track section is aligned with the second track section, in an end-to-end configuration. The first track section 500 may be aligned with the second track section 500 by engaging a first hook portion 590 of the first track section 500 in a second hook portion 592 of the second track section 500. The first and second track sections 500 and thus temporarily held together in an aligned disposition, in an end-to-end configuration, which eases the subsequent assembly operations. The first inner coupler connector 524 of the inner coupler 540 is connected to the first inner section connector 524 of the first track section 500. The second inner coupler connector 548 of the inner coupler 540 is connected to the second inner section connector 548 of the second track section 500. The first outer coupler connector 556 of the outer coupler 550 is connected to the first outer section connector 532 of the first track section. The second outer coupler connector 558 of the outer coupler 550 is connected to the second outer section connector 534 the second track section 500. Connection of the first inner coupler connector 546 to the first inner section connector 524 of the first track section 500 may be done by a lateral translation. Likewise, connection of the second inner coupler connector 526 to the second inner section connector 526 of the second track section 500 may be done by a lateral translation. The same applies to the connection of the first outer coupler connector 556 to the first outer section connector 532 of the first track section 500 and to the connection of the second outer coupler connector 558 to the second outer section connector 534 of the second track section 500, may be all be done by a lateral translation. The inner and outer couplers 540, 550 may be locked to the first and second track sections 500, using a securing means such that the inner and outer couplers 540, 550 are generally laterally fixed relative to the first and second track sections 500. Connection or disassembly of the first and second track sections 500 may be performed manually without requiring the use of any specialized tools.

It should be noted that some of the above-described operations are optional and the order of some of these operations may be modified.

### CLAUSES

First clause: A track segment for a segmented track, the track segment comprising a first track section comprising: a section body; a first connecting portion disposed at a first longitudinal end of the section body, the first connecting portion having; a first inner connecting surface defining a first inner section connector, a first outer connecting surface opposite to the first inner connecting surface, the first outer connecting surface defining a first outer section connector, and a first engaging surface extending between the first inner and outer connecting surfaces and configured to abut on a second engaging surface of a second connecting portion of a second track section; and an inner coupler having a first inner coupler connector and a second inner coupler connector, the first and second inner couplers being longitudinally spaced from one another, the first inner coupler connector being configured to connect to the first inner section connector of the first connecting portion of the first track section, the second inner coupler connector being configured to connect to a second inner section connector of the second connecting portion of the second track section; and an outer coupler having a first outer coupler connector and a second outer coupler connector, the first and second outer coupler connectors being longitudinally spaced from one another, the first outer coupler connector being configured to connect to the first outer section connector of the first connecting portion of the first track section, the second outer coupler connector being configured to connect to a second outer section connector of the second connecting portion of the second track section.

Second clause: The track segment of the first clause, further comprising the second track section.

Third clause: The track segment of the previous clauses, wherein the first track section comprises a second connecting portion at a second longitudinal end of the section body opposite from the first longitudinal end, the second connecting portion being configured to be connected to a third track section using a supplementary inner coupler and a supplementary outer coupler.

Fourth clause: The track segment of the first or second clauses, wherein: the track segment is reinforced with longitudinal reinforcing cables; the first track section comprises a cable attachment section at a second longitudinal end of the section body opposite from the first longitudinal end, the cable attachment section being configured to receive first ends of the longitudinal reinforcing cables; and the longitudinal reinforcing cables have second ends configured for attachment to another track segment.

Fifth clause: The track segment of any one of the previous clauses, wherein the section body is made of elastomeric material.

Sixth clause: The track segment any one of the previous clauses, wherein: the section body includes: an inner surface having at least one inner body lug, and an outer surface opposite to the inner surface, the outer surface having at least one outer body lug; the inner coupler includes at least one inner coupler lug, and the outer coupler includes at least one outer coupler lug.

Seventh clause: The track segment of the sixth clause, wherein: the at least one inner body lug comprises at least one driving lug and at least one guiding lug; and the at least one inner coupler lug comprises at least one driving lug and at least one guiding lug.

Eight clause: The track segment of the sixth or seventh clause, wherein the at least one outer body lug comprises at least one ground-engaging lug; and the at least one outer coupler lug comprises at least one ground-engaging lug.

Ninth clause: The track segment of any one of the sixth clause to the eight clause, wherein: the at least one inner body lug and the at least one inner coupler lug are longitudinally spaced; and the at least one outer body lug and the at least one outer coupler lug are longitudinally spaced.

Tenth clause: The track segment of any one of the previous clauses, wherein the first and second connecting portions extend laterally along at least about 70% of a width of the first track section.

Eleventh clause: The track segment of any one of the previous clauses, wherein each of the first and second inner section connectors forms one of an inner mortise and an inner tenon, each of the first inner and second coupler connectors forms another one of the inner mortise and the inner tenon; and wherein each respective pair including one the inner mortises and one of the inner tenons is configured to form an inner dovetail joint when the inner coupler is assembled with the first and second track sections.

Twelfth clause: The track segment of any one of the previous clauses, wherein: each of the first and second outer section connectors forms one of an outer mortise and an outer tenon, each of the first outer and second coupler connectors forms another one of the outer mortise and the outer tenon; wherein each respective pair including one the outer mortises and one of the outer tenons is configured to form an outer dovetail joint when the outer coupler is assembled with the first and second track sections.

Thirteenth clause: The track segment of any one of the previous clauses, wherein the first engaging surface has a first anchoring portion, and the second engaging surface has a second anchoring portion.

Fourteenth clause: The track segment of the thirteenth, wherein one of the first and second anchoring portions includes a plurality of laterally distributed tenons; another one of the first and second anchoring portions includes a plurality of laterally distributed mortises; and the plurality of laterally distributed mortises and the plurality of laterally distributed tenons are configured to form a plurality of laterally distributed dovetail joints when the first and second track sections are assembled.

Fifteenth clause: The track segment of any one of the previous clauses, wherein the first connecting portion has a first hook portion and the second connecting portion has a second hook portion.

Sixteenth clause: The track segment of the fifteenth clause, wherein the first hook portion and the second hook portion are configured to align and temporarily hold the first connecting portion of the first track section relative to the second connecting portion of the second track section before the inner and outer couplers connect to the first and second track sections.

Seventeenth clause: The track segment of any one of the previous clauses, wherein at least one of the first track and second sections further includes a securing means for locking the inner and outer couplers to the first and second track segments.

Eighteenth clause: The track segment of any one of the previous clauses, wherein the inner and outer couplers are configured to form a rigid connection between the first and second track sections.

Nineteenth clause: The track segment of any one of the previous clauses, wherein the first connecting portion comprises a flexible portion between the first longitudinal end of the section body and the first inner and outer section connectors, whereby an assembly formed by connecting the inner coupler, the outer coupler and the first inner and outer section connectors may flex in relation to the section body.

Twentieth clause: A track segment for a segmented track, the track segment comprising: a first track section comprising: a first section body; a first connecting portion disposed at a first longitudinal end of the first section body, the first connecting portion having; a first inner connecting surface defining a first inner section connector, a first outer connecting surface opposite to the first inner connecting surface, the first outer connecting surface defining a first outer section connector, a first engaging surface extending between the first inner and outer connecting surfaces, and a first cable attachment section at a first longitudinal extremity of the first section body opposite from the first longitudinal end, the cable attachment section being configured to receive ends of at least one first longitudinal reinforcing cable; at least one second track section, each second track section comprising: a second section body; a second connecting portion disposed at a second longitudinal end of the second section body, the second connecting portion having; a second inner connecting surface defining a second inner section connector, a second outer connecting surface opposite to the second inner connecting surface, the second outer connecting surface defining a second outer section connector, a second engaging surface extending between the second inner and outer connecting surfaces, and a third connecting portion disposed at a third longitudinal end of the third section body, the third connecting portion having; a third inner connecting surface defining a third inner section connector, a third outer connecting surface opposite to the third inner connecting surface, the third outer connecting surface defining a third outer section connector, a third engaging surface extending between the third inner and outer connecting surfaces; a first inner coupler having a first inner coupler connector and a second inner coupler connector, the first and second inner couplers being longitudinally spaced from one another, the first inner coupler connector being configured to connect to the first inner section connectors of the first connecting portion of the first track section, the second inner coupler connector being configured to connect to the second inner section connector of the second connecting portion of the at least one second track section when the first engaging surface of the first track section abuts on the second engaging surface of the at least one second track section; and a first outer coupler having a first outer coupler connector and a second outer coupler connector, the first and second outer coupler connectors being longitudinally spaced from one another, the first outer coupler connector being configured to connect to the first outer section connector of the first connecting portion of the first track section, the second outer coupler connector being configured to connect to the second outer section connector of the second connecting portion of the at least one second track section when the first engaging surface of the first track section abuts on the second engaging surface of the at least one second track section.

Twenty-first clause: The track segment of the twentieth clause, wherein the at least one second track section comprises two or more second track sections, a first one of the second track sections being connected to the first track section by the first inner coupler and the first outer coupler, a second one of the two or more second track sections being connected to the first one of the two or more second track sections by a second inner coupler and a second outer coupler.

Twenty-second clause: The track segment of the twentieth or twenty-first clauses, further comprising: a third track section comprising: a third section body; a fourth connecting portion disposed at a fourth longitudinal end of the third section body, the fourth connecting portion having; a fourth inner connecting surface defining a fourth inner section connector, a fourth outer connecting surface opposite to the fourth inner connecting surface, the fourth outer connecting surface defining a fourth outer section connector, a fourth engaging surface extending between the fourth inner and outer connecting surfaces, and a second cable attachment section at a second longitudinal extremity of the third section body opposite from the fourth longitudinal end, the second cable attachment section being configured to receive first of at least one second longitudinal reinforcing cable; a third inner coupler having a third inner coupler connector and a fourth inner coupler connector, the third and fourth inner couplers being longitudinally spaced from one another, the third inner coupler connector being configured to connect to the third inner section connector of the third connecting portion of the at least one second track section, the fourth inner coupler connector being configured to connect to the second inner section connector of the second connecting portion of the at least one second track section when the third engaging surface of the at least one second track section abuts on the fourth engaging surface of the third track section; and a third outer coupler having a third outer coupler connector and a fourth outer coupler connector, the third and fourth outer coupler connectors being longitudinally spaced from one another, the third outer coupler connector being configured to connect to the third outer section connector of the third connecting portion of the first at least one second track section, the fourth outer coupler connector being configured to connect to the second outer section connector of the second connecting portion of the at least one second track section when the third engaging surface of the at least one second section abuts on the fourth engaging surface of the third track section.

Twenty-third clause: A segmented track for a track system comprising a plurality of the track segments according to any one of the previous clauses.

Twenty-fourth clause: A vehicle comprising: a frame; an engine supported by the frame; and at least two track systems operatively connected to the engine, each of the at least two track systems including the segmented track of claim 23.

Twenty-fifth clause: A track coupling assembly for a segmented track, the track coupling assembly comprising: a) a first connecting portion of a first track section, the first connecting portion having a first inner connecting surface, a first outer connecting surface and a first engaging surface extending between the first inner and outer connecting surfaces; b) a second connecting portion of a second track section, the second connecting portion having a second inner connecting surface, a second outer connecting surface and a second engaging surface extending between the second inner and outer connecting surfaces, the second engaging surface of the first track section being configured to abut the first engaging surface of a second track section; and c) an inner coupler configured to connect to the first inner connecting surface of the first track section and to a second inner connecting surface of the second track section; and d) an outer coupler configured to connect to the first outer connecting surface of the first track section and to a second outer connecting surface of the second track section; wherein connection of the inner and outer couplers with the first and second connecting portions results in the first and second engaging surfaces abutting, and couples the first track section with the second track section.

Twenty-sixth clause: A method for selectively and removably connecting a first track section of a segmented track to a second track section of the segmented track, the first and second track sections respectively having first and second inner section connectors and first and second outer section connectors, the method comprising: aligning the first track section with the second track section; connecting a first inner coupler connector of an inner coupler to the first inner section connector of the first track section; connecting a second inner coupler connector of the inner coupler to the second inner section connector the second track section; connecting a first outer coupler connector of an outer coupler to the first outer section connector of the first track section; and connecting a second outer coupler connector of the outer coupler to the second outer section connector the second track section.

Twenty-seventh clause: The method of the twenty-sixth clause, wherein: connection of the first inner coupler connector to the first inner section connector of the first track section is done by a lateral translation; connection of the second inner coupler connector to the second inner section connector of the second track section is done by a lateral translation; connection of the first outer coupler connector to the first outer section connector of the first track section is done by a lateral translation; and connection of the second outer coupler connector to the second outer section connector of the second track section is done by a lateral translation.

Twenty-eight clause: The method of the twenty-sixth or twenty-seventh clause, wherein the first track section is aligned with the second track section by a first hook portion of the first track section and a second hook portion of the second track section.

Twenty-ninth clause: The method of any one of the twenty-sixth clause to the twenty-eight clause, wherein the inner and outer couplers are secured to the first and second track sections such that the inner and outer couplers are generally laterally fixed relative to the first and second track sections.

Thirtieth clause: The method of any one of the twenty-sixth clause to the twenty-ninth clause, wherein the connection of the first and second track sections is performed manually.

Thirty-first clause: The method of the thirtieth clause, wherein the first and second track sections are connected without specialized tools.

Thirty-second clause: A track section for a segmented track, the track section comprising: a section body made of elastomeric material having: an inner surface having at least one inner lug, an outer surface opposite the inner surface and having at least one outer lug, a first body end and a second body end opposite the first body end; a first connecting portion connected to the first body end of the section body and configured for connecting to a second connecting portion of a paired track section, the first connecting portion defining: an inner joining surface including an inner section connector and including an inner section connector, an outer joining surface opposite the inner joining surface and including an outer section connector, and a first engaging surface extending from the inner joining surface to the outer joining surface; and a coupler assembly including an inner coupler having: an inner lug portion and an inner connecting portion opposite the inner lug portion and complementary to the inner section connector of the first connecting portion of the track section and to a second inner section connector of the paired track section, an outer coupler having: an outer lug portion and an outer connecting portion opposite the outer lug portion and complementary to the outer section connector of the first connecting portion of the track section and to a second outer section connector of the paired track section, and wherein the inner coupler and the outer coupler are configured to respectively connect, via lateral translation, (i) to the inner section connector of the first connecting portion of the track section and to the second inner section connector of the paired track section, and (ii) to the outer section connector of the first connecting portion of the track section and to the second outer section connector of the paired track section, to thereby form a rigid joint between the first and second connecting portions when the first engaging surface of the track section abuts on a second engaging surface of the paired track section.

Thirty-third clause: The track section of claim thirty-second clause, wherein the first and second connecting portions extend on at least 80% of a width of the section body.

Thirty-fourth clause: The track section of the thirty-second clause or the thirty-third clause, wherein the at least one inner lug of the section body and the inner lug portion of the inner coupler are drive lugs or guide lugs.

Thirty-fifth clause: The track section of any one of the thirty-second clause to the thirty-fourth clause, wherein the at least one inner lug of the section body and the outer lug portion of the outer coupler are ground-contacting lugs.

Thirty-sixth clause: The track section of claim any one of the thirty-second clause to the thirty-fifth clause, wherein the inner connecting portion includes a first metallic part and the inner lug portion is connected to the first metallic part.

Thirty-seventh clause: The track section of any one of the thirty-second clause to the thirty-sixth clause, wherein the outer connecting portion includes a second metallic part and the outer lug portion is connected to the second metallic part.

Thirty-eight clause: The track section of any one of the thirty-second clause to the thirty-seventh clause, wherein the first connecting portion is different from the second connecting portion.

Thirty-ninth clause: The track section of any one of the thirty-second clause to the thirty-eight clause, wherein the first and second connecting portions further each comprises a complementary hook portion configured to temporarily align and hold the first and second connecting portions together during installation of the coupler assembly.

Fortieth clause: The track section of any one of the thirty-second clause to the thirty-ninth clause, wherein the inner section connectors of the first and second connecting portions are configured to form one or more dovetail joints.

Forty-first clause: The track section of the fortieth clause, wherein the coupler assembly further comprises at least one mistake-proof feature.

Forty-second clause: The track section of the forty-first clause, wherein one of the at least one mistake-proof feature comprises: mortises formed on one of the inner and outer couplers and tenons formed on the other one of the inner and outer couplers; corresponding tenons and mortises formed on the first and second connecting portions; and whereby installing the inner coupler on the outer section connectors and to prevent installing the outer coupler on the inner section connectors is prevented.

Forty-third clause: The track section of the forty-first clause or the forty-second clause 42, wherein one of the at least one mistake-proof feature is formed by tapering, in a lateral direction, mortises on one of the first and second engaging surfaces and by tapering, in the lateral direction, tenons on the other one of the first and second engaging surfaces to prevent sliding the inner or outer couplers in an incorrect direction on the first and second connecting portions of the track sections.

Forty-fourth clause: The track section of any one of the thirty-second clause to the forty-third clause, wherein the coupler assembly further comprises a securing means selectively preventing lateral translation of the inner and outer couplers relative to the track section.

Forty-fifth clause: The track section of the forty-fourth clause, wherein the securing means includes a separate part.

Forty-sixth clause: The track section of the forty-fourth clause, wherein the securing means is integrated in the track section and in the inner and outer couplers.

Forty-seventh clause: The track section of any one of the thirty-second clause to the forty-sixth clause, wherein a first of the engaging surfaces further includes a first anchoring portion and a second of the engaging surfaces further includes a second anchoring portion complementary to the first anchoring portion.

Forty-eight clause: The track section of the forty-seventh clause, wherein the anchoring portions are configured to form a dovetail joint.

Forty-ninth clause: A segmented track for a tracked vehicle, the segmented track comprising a plurality of track sections as defined in any one of the thirty-second clause to the forty-eight clause and joined end-to-end to form a closed loop.

Fiftieth clause: A vehicle having mounted thereto a segmented track as defined in the forty-ninth clause.

Fifty-first clause: A method for releasably joining track sections, each track section having an inner section connector and an outer section connector, the method comprising: aligning track sections with one another in an end-to-end configuration; engaging an inner coupler with the inner section connectors of each pair of adjacent track sections via a lateral translation; and engaging an outer coupler with the outer section connectors of each pair of adjacent track sections via a lateral translation.

Fifty-second clause: The method of the fifty-first clause, in which the track sections of each pair are temporary aligned by a hook portion.

Fifth-third clause: The method of the fifty-first clause, further comprising securing the lateral movement of the inner and outer couplers using a securing means.

Fifty-fourth clause: The method of the fifty-first clause, wherein the sections are connected without specialized tools.

Fifth-fifth clause: A track segment for a segmented track, the track segment comprising: a first track section comprising: a section body; a first connecting portion disposed at one end of the section body, the first connecting portion defining: a first inner section connector, a first outer section connector opposite from the first inner section connector, and a first engaging surface configured to abut on a second engaging surface of a second connecting portion of a second track section; and an inner coupler having a first inner coupler connector and a second inner coupler connector configured to respectively connect to the first inner section connector of the first track section and to a second inner section connector of the second track section; and an outer coupler having a first outer coupler connector and a second outer coupler connector configured to respectively connect to the first outer section connector of the first track section and to a second outer section connector of the second connecting portion of the second track section.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A track segment for a segmented track, the track segment comprising:
a first track section comprising:
a section body;
a first connecting portion disposed at a first longitudinal end of the section body, the first connecting portion having;
a first inner connecting surface defining a first inner section connector,
a first outer connecting surface opposite to the first inner connecting surface, the first outer connecting surface defining a first outer section connector, and
a first engaging surface extending between the first inner and outer connecting surfaces and configured to abut on a second engaging surface of a second connecting portion of a second track section; and
an inner coupler having a first inner coupler connector and a second inner coupler connector, the first and second inner couplers being longitudinally spaced from one another, the first inner coupler connector being configured to connect to the first inner section connector of the first connecting portion of the first track section, the second inner coupler connector being configured to connect to a second inner section connector of the second connecting portion of the second track section; and
an outer coupler having a first outer coupler connector and a second outer coupler connector, the first and second outer coupler connectors being longitudinally spaced from one another, the first outer coupler connector being configured to connect to the first outer section connector of the first connecting portion of the first track section, the second outer coupler connector being configured to connect to a second outer section connector of the second connecting portion of the second track section.

2. The track segment of claim 1, further comprising the second track section.

3. The track segment of claim 1, wherein the first track section comprises a second connecting portion at a second longitudinal end of the section body opposite from the first longitudinal end, the second connecting portion being configured to be connected to a third track section using a supplementary inner coupler and a supplementary outer coupler.

4. The track segment of claim 1, wherein:
the track segment is reinforced with longitudinal reinforcing cables;
the first track section comprises a cable attachment section at a second longitudinal end of the section body opposite from the first longitudinal end, the cable attachment section being configured to receive first ends of the longitudinal reinforcing cables; and
the longitudinal reinforcing cables have second ends configured for attachment to another track segment.

5. The track segment of claim 1, wherein the section body is made of elastomeric material.

6. The track segment claim 1, wherein:
the section body includes:
an inner surface having at least one inner body lug, and
an outer surface opposite to the inner surface, the outer surface having at least one outer body lug;
the inner coupler includes at least one inner coupler lug, and
the outer coupler includes at least one outer coupler lug.

7. The track segment of claim 6, wherein:
the at least one inner body lug comprises at least one driving lug and at least one guiding lug; and
the at least one inner coupler lug comprises at least one driving lug and at least one guiding lug.

8. The track segment of claim 6, wherein:
the at least one outer body lug comprises at least one ground-engaging lug; and
the at least one outer coupler lug comprises at least one ground-engaging lug.

9. The track segment of claim 6, wherein:
the at least one inner body lug and the at least one inner coupler lug are longitudinally spaced; and
the at least one outer body lug and the at least one outer coupler lug are longitudinally spaced.

10. The track segment of claim 1, wherein the first and second connecting portions extend laterally along at least about 70% of a width of the first track section.

11. The track segment of claim 1, wherein:
each of the first and second inner section connectors forms one of an inner mortise and an inner tenon,
each of the first inner and second coupler connectors forms another one of the inner mortise and the inner tenon, and
wherein each respective pair including one the inner mortises and one of the inner tenons is configured to form an inner dovetail joint when the inner coupler is assembled with the first and second track sections.

12. The track segment of claim 1, wherein:
each of the first and second outer section connectors forms one of an outer mortise and an outer tenon,
each of the first outer and second coupler connectors forms another one of the outer mortise and the outer tenon; and
wherein each respective pair including one the outer mortises and one of the outer tenons is configured to form an outer dovetail joint when the outer coupler is assembled with the first and second track sections.

13. The track segment of claim 1, wherein the first engaging surface has a first anchoring portion, and the second engaging surface has a second anchoring portion.

14. The track segment of claim 13, wherein:
one of the first and second anchoring portions includes a plurality of laterally distributed tenons;
another one of the first and second anchoring portions includes a plurality of laterally distributed mortises; and
the plurality of laterally distributed mortises and the plurality of laterally distributed tenons are configured to form a plurality of laterally distributed dovetail joints when the first and second track sections are assembled.

15. The track segment of claim 1, wherein the first connecting portion has a first hook portion and the second connecting portion has a second hook portion.

16. The track segment of claim 15, wherein the first hook portion and the second hook portion are configured to align and temporarily hold the first connecting portion of the first track section relative to the second connecting portion of the second track section before the inner and outer couplers connect to the first and second track sections.

17. The track segment of claim 1, wherein at least one of the first track and second sections further includes a securing means for locking the inner and outer couplers to the first and second track segments.

18. The track segment of claim 1, wherein the inner and outer couplers are configured to form a rigid connection between the first and second track sections.

19. The track segment of claim 1, wherein the first connecting portion comprises a flexible portion between the first longitudinal end of the section body and the first inner and outer section connectors, whereby an assembly formed by connecting the inner coupler, the outer coupler and the first inner and outer section connectors may flex in relation to the section body.

20.-22. (canceled)

23. A segmented track for a track system comprising a plurality of the track segments according to claim 1.

24.-55. (canceled)
